(19) United States
(12) Patent Application Publication
(10) Pub. No.: US 2022/0381290 A1
(43) Pub. Date: Dec. 1, 2022

(54) VACUUM PUMP

(71) Applicant: Leybold GmbH, Cologne (GB)

(72) Inventors: Matthias Nahrwold, Cologne (DE); Dirk Schiller, Cologne (DE)

(21) Appl. No.: 17/826,999

(22) Filed: May 27, 2022

(30) Foreign Application Priority Data
May 28, 2021 (GB) 2107625.2

(51) Int. Cl. F16C 25/08; F16C 35/067; F16C 33/58

(52) U.S. Cl. CPC F16C 25/083; F16C 35/067; F16C 33/583; F16C 2360/00

(57) ABSTRACT

Vacuum pump comprising a housing, a rotor shaft disposed in the housing, at least one bearing rotatably supporting the rotor shaft against the housing including an inner race in contact with the rotor shaft and an outer race in contact with the housing, and an axial spring applying an axial force onto the outer race, wherein a bearing ring is disposed between the axial spring and the outer race, the bearing ring applying a clamping force to the housing.

### CROSS-REFERENCE OF RELATED APPLICATION

This application claims priority of British Application No. 2107625.2, filed May 28, 2021, the content of which is hereby incorporated by reference in its entirety.

### FIELD

The present invention relates to a vacuum pump and in particular to a bearing of a vacuum pump.

### BACKGROUND

Common vacuum pumps comprise a housing with an inlet and an outlet. In the housing a rotor shaft is rotatably supported by at least one bearing. Usually, two bearings are implemented to support the rotor shaft. Bearings are usually built as roller bearing such as ball bearings. The rotor shaft is driven by an electric motor and comprises at least one pump element interacting with either a stator built by the housing of the vacuum pump and/or interacting with the pump elements of a second rotor shaft. Thus, by rotation of the rotor shaft a gaseous medium is conveyed from the inlet of the vacuum pump to the outlet of the vacuum pump.

In particular, the two rotors of a dry vacuum pump are supported by ball bearings that are preloaded via the outer bearing race by means of axial spring force to create a defined contact angle of the bearing. The rotor shaft arrangement consists of a fixed bearing and a floating bearing. A bearing seat bore of the housing for the floating bearing is larger than for the fixed bearing so that the floating bearing can move axially in the bearing seat when the rotor expands thermally relatively the pump housing. Due to the loose fit between the bearing outer race and the bearing seat, the floating bearing can also move radially. As the design of the preload spring offers only little radial stiffness, the floating bearing can easily follow radial displacements of the rotating shaft caused by runout errors, residual imbalances, or gas forces. This results in vibration and noise.

Thus, it is an object of the present invention to provide a vacuum pump being operated with less noise and more stable.

The discussion above is merely provided for general background information and is not intended to be used as an aid in determining the scope of the claimed subject matter. The claimed subject matter is not limited to implementations that solve any or all disadvantages noted in the background.

### SUMMARY

The technical problem of the prior art is solved by a vacuum pump according to claim 1.

The vacuum pump according to the present invention is preferably built as dry vacuum pump. The vacuum pump comprises a housing and a rotor shaft disposed in the housing. Further, the vacuum pump comprises at least one roller bearing rotatably supporting the rotor shaft against the housing and preferably arranged in a bearing seat bore. The roller bearing includes an inner race in contact with the rotor shaft and an outer race in contact with the housing, i.e. a surface of the bearing seat bore. Between the inner race and the outer race, a roller element, such as a ball for a ball bearing or the like, is disposed. Furthermore, an axial spring is implemented in order to apply an axial force onto the outer race. Thus, by the axial force applied by the axial spring, thermal expansion of the rotor shaft can be compensated for. Upon thermal expansion of the rotor shaft, the roller bearing is allowed to move in the direction of the thermal expansion, thereby compressing the axial spring. If thermal expansion is reduced, the roller bearing is brought into its initial position by the axial force of the axial spring.

Therein, in accordance to the present invention, a bearing ring is disposed between the axial spring and the outer race. The bearing ring applies a clamping force to the housing, i.e. a surface of the bearing seat bore. Thus, by the bearing ring a radial force is provided which can be transferred to the outer race of the roller bearing. By the radial force applied by the bearing ring onto the outer race, radial movement of the roller bearing in the radial direction is hampered reducing vibration and thereby reducing noise of the vacuum pump.

Preferably, the roller bearing and the bearing ring are axially movable. Thus, the roller bearing and the bearing ring move in conjunction under thermal expansion of the rotor shaft. In particular, the clamping force applied by the bearing ring is damping, on the one hand, acceleration/movement of the outer race in the axial direction due to the axial force of the axial spring, but on the other hand, applying a radial force onto the outer race and damping vibration and noise along the radial direction. Since thermal expansion is not a fast effect, reducing acceleration of the outer race of the roller bearing in the axial direction has no disadvantage for the operation of the vacuum pump and providing the sole benefit of reduction of noise of the vacuum pump during operation.

Preferably, the bearing ring is in direct contact with the outer race applying a friction force into the outer race. In particular, due to friction between the bearing ring and the outer race of the roller bearing, radial movement of the outer race or the roller bearing in general is reduced, reducing noise generated by the vacuum pump.

Preferably, the bearing ring comprises a textured surface. In particular, the textured surface is in direct contact with the outer race of the roller bearing. Thus, by the texture of the textured surface, the friction force applied to the outer race of the roller bearing can be customized to the intended damping of the bearing ring.

Preferably, the bearing ring is built as a lock ring comprising a gap. Due to the gap, the bearing ring can be compressed in order to reduce the perimeter of the bearing ring to be inserted into the housing, i.e. the bearing seat bore of the housing. Upon release, the bearing ring returns to its original perimeter applying the clamping force onto the housing of the vacuum pump.

Preferably, the bearing ring comprises a non-constant cross-section along its perimeter in order to provide an even clamping force along the bearing ring. In particular, in the area of the gap, the cross-section is decreased in order to decrease the clamping force in the area of the gap.

Preferably, the bearing ring comprises a slanted surface being oriented towards the roller bearing and being in direct contact with the outer race. By the slanted surface, a radial force component of the axial force of the axial spring is created and applied to the outer race. Therein, the radial force is in radial direction towards the central axis of the rotor shaft hampering radial movement of the roller bearing, thereby reducing noise. In particular, the slanted surface can be further textured in order to create also a friction force further hampering the radial movement of the outer race or the roller bearing.

Preferably, the contact surface of the outer race being in contact with the bearing ring is rounded or chamfered. Usually, the edges of common roller bearings are rounded or chamfered. Thus, by the rounded or chamfered edges of the roller bearing, in particular in connection with the slanted surface of the bearing ring, a radial force component is created being applied to the outer race and the roller bearing in order to hamper radial movement and thereby reducing noise of the vacuum pump.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF THE DRAWINGS

In the following, the present invention is described in more detail with reference to the accompanied drawings.

The Figures show:

FIG. 1, is a sectional side view of a portion of a vacuum pump in accordance with a first embodiment,

FIG. 2A, is a top view of a bearing ring of a first embodiment,

FIG. 2B, is a top view of a bearing ring of a second embodiment, and

FIG. 3, is a sectional side view of a portion of a vacuum pump in accordance with a further embodiment.

### DETAILED DESCRIPTION

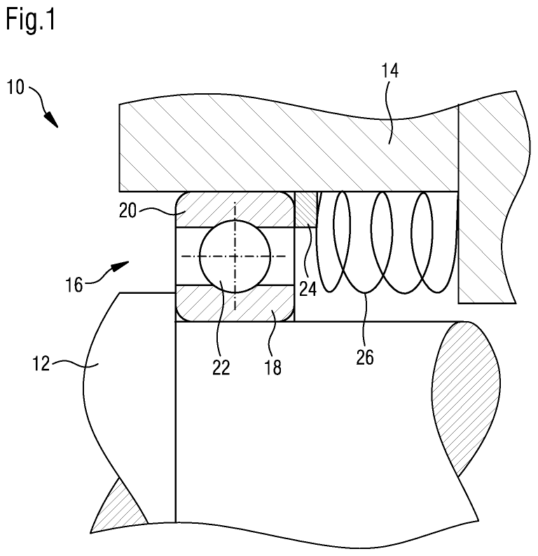

Referring to FIG. 1 showing a rotor shaft 12 rotated by an electro motor and supported against a housing 14 of the vacuum pump by a roller bearing 16, exemplified in FIG. 1 as ball bearing. The bearing is arranged in a bearing seat bore of the housing 14. The roller bearing 16 comprises an inner race 18 directly connected to the rotor shaft 12 and rotated together with the shaft 12 and an outer race 20 in direct connection with the housing 14. Between the inner race 18 and the outer race 20, a roller element 22, exemplified as ball element, is disposed in order to allow rotation of the rotor shaft 12 in the housing 14. Therein, the roller bearing 16 is built as floating bearing, i.e. at least the outer race 20 is not clampingly fixed in its axial direction to the housing 14, i.e. an inner surface of the bearing seat bore.

An axial spring 26 is provided applying an axial force to the outer race 20. Thus, upon thermal expansion of the rotor shaft 12, the roller bearing 16 is moved in an axial direction against the axial force of the axial spring 26. If the thermal expansion of the rotor shaft 12 is reduced again, the roller bearing 16 is reverted to its initial position by the axial force of the axial spring 26. Thereby, the axial spring 26 cannot provide a radial stiffness and radial movement of the outer race or the roller bearing 16 is possible in conventional vacuum pumps. Thus, according to the present invention, a bearing ring 24 is disposed between the axial spring 26 and the outer race 20. The bearing ring 24 is clampingly fixed to the housing 14 by its outer perimeter. However, the bearing ring 24 can still be moved in axial direction in connection with the roller bearing 16 either by the thermal expansion of the rotor shaft 12 or by the axial force of the axial spring 26. Therein, the bearing ring 24 directly abuts a surface of the outer race 20 creating a friction force in a radial direction upon radial movement of the roller bearing 16. Due to the friction between the bearing ring 24 and the outer race 20 of the roller bearing 16, radial movement of the roller bearing 16 is hampered, thereby effectively reducing noise of the vacuum pump. Therein, the contact surface of the bearing ring 24 contacting the outer race 20 of the roller bearing 16 might be textured in order to increase the friction force or at least tailor the applied friction force to the required values.

Thus, by the bearing ring 24, acceleration of the roller bearing 16 in axial direction by the axial force of the axial spring 26 is reduced due to the radial force provided by the bearing ring 24. However, movement of the roller bearing 16 is still possible and at the same time radial movement of the roller bearing 16 is hampered due to the applied radial friction force towards the center access of the rotor shaft 12.

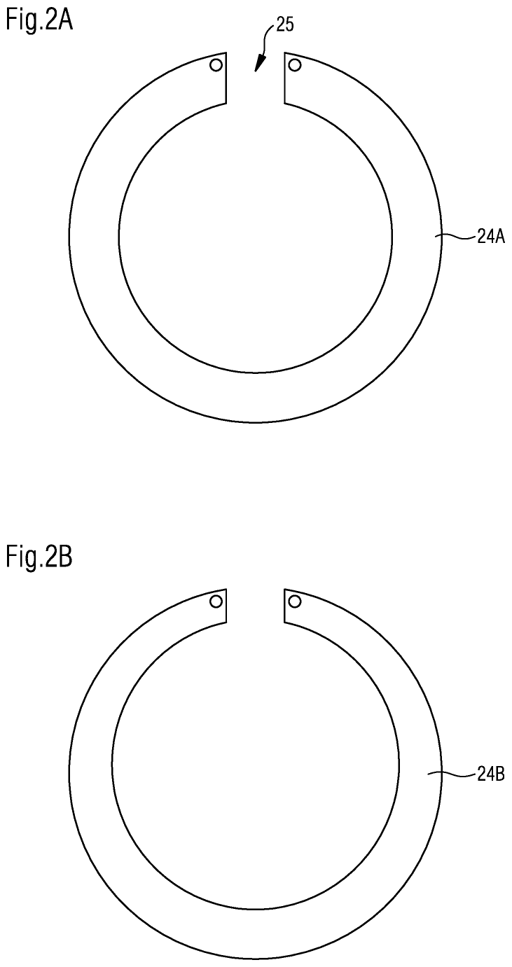

Referring to FIG. 2A showing a first embodiment of the bearing ring 24A built as clamping ring having a gap. By compressing the ends of the clamping ring 24A together, the perimeter of the bearing ring 24A is reduced. In this condition, the bearing ring 24A can be introduced into the bearing seat bore of the housing 14 accommodating the bearing of the vacuum pump.

In another embodiment shown in FIG. 2B, the bearing ring 24B shows a non-constant cross-section, thereby evenly distributing the clamping force applied by the bearing ring 24B to the housing 14 along the perimeter of the bearing ring 24B.

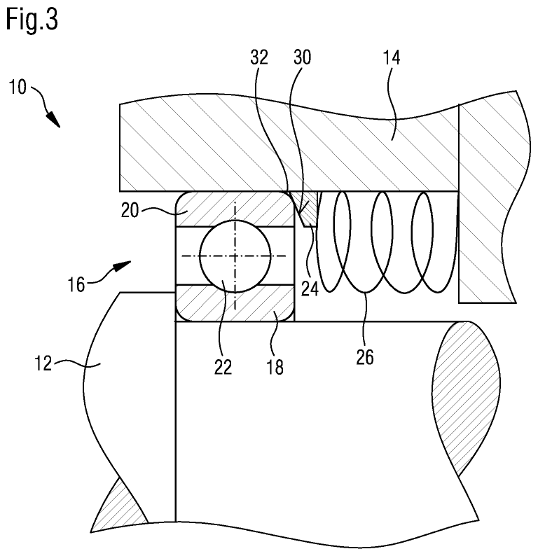

Referring to FIG. 3 showing another embodiment of the present invention. Therein, same or similar elements are provided with the identical reference signs.

In the embodiment of FIG. 3, the bearing ring 24 has a slanted surface 30 which is angled towards the roller bearing 16. The slanted surface 30 is in contact with a rounded or chamfered edge of the outer race 20 of the roller bearing 16. By interaction of the slanted surface 30 and the chamfered or rounded surface 32 of the roller bearing 16, a radial force component towards the center axis of the rotor shaft is created from the axial force of the axial spring 26. By this radial force component, radial movement of the roller bearing 16 is hampered, thereby reducing noise of the vacuum pump but still allowing the bearing 16 to move under thermal expansion.

In particular, the vacuum pump is a dry vacuum pump, wherein in those vacuum pumps noise is most critical due to absence of any friction and a less gas load. Thus, by the present invention, noise produced by vacuum pumps and in particular dry vacuum pumps can be further reduced enhancing the usability and versatility of these vacuum pumps.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A vacuum pump comprising
a housing;
a rotor shaft disposed in the housing;
at least one bearing rotatably supporting the rotor shaft against the housing including an inner race in contact with the rotor shaft and an outer race in contact with the housing; and
an axial spring applying an axial force onto the outer race,
wherein a bearing ring is disposed between the axial spring and the outer race, the bearing ring applying a clamping force to the housing.

2. The vacuum pump according to claim 1, wherein the bearing and bearing ring are axially movable.

3. The vacuum pump according to claim 1, wherein the bearing ring is in direct contact with the outer race applying a friction force to the outer race.

4. The vacuum pump according to claim 1, wherein the bearing ring comprises textured surface.

5. The vacuum pump according to claim 1, wherein the bearing ring comprises a non-constant cross-section along its perimeter to provide an even clamping force along the bearing ring.

6. The vacuum pump according to claim 1, wherein the bearing ring comprises a slanted surface being oriented towards the bearing and in direct contact with the outer race creating a radial force component of the axial force of the axial spring applied to the outer race.

7. The vacuum pump according to claim 1, wherein a contact surface of the outer race being in contact with the bearing ring is rounded.
